(19) United States
(12) Patent Application Publication
(10) Pub. No.: US 2018/0189699 A1
(43) Pub. Date: Jul. 5, 2018

(54) A METHOD AND SYSTEM FOR LOCATING REGULATORY INFORMATION

(71) Applicant: eRevalue Limited, London (GB)

(72) Inventors: Jean-Philippe LECOURT, London (GB); Jeltje LECOURT-ALMA, London (GB); Jerome BASDEVANT, Valencia (ES)

(21) Appl. No.: 15/736,731

(22) PCT Filed: Jun. 15, 2016
(86) PCT No.: PCT/GB2016/051783

§ 371 Date: Dec. 14, 2017

Related U.S. Application Data
(60) Provisional application No. 62/175,735, filed on Jun. 15, 2015.

(51) Int. Cl. G06Q 10/06; G06F 17/30; H04L 29/08

(52) U.S. Cl. CPC G06Q 10/0637; G06Q 10/06315; G06Q 50/18; G06F 17/30613; H04L 67/306; G06F 17/30734

(57) ABSTRACT

The present invention relates to a computer-implemented method for locating regulatory information. The method including the steps of constructing a corporate profile; identifying regulatory information from a plurality of sources; and mapping the corporate profile to the identified regulatory information to locate relevant regulatory information. A system is also disclosed.

### FIELD OF INVENTION

The present invention is in the field of business intelligence. More particularly, but not exclusively, the present invention relates to a method and system for locating relevant regulatory information for an organisation.

### BACKGROUND

One aspect of business intelligence is providing and assessing regulatory information relevant to an organisation.

Several software platforms provide access to regulatory information to organisations such as Peppermint Technology, Advanced Legal, Soslegal, Washlaw, Rocket Matter, Mycase, Prevail, Billquick, and CosmoLex. These are of an administrative nature (for internal use/internal knowledge management purposes) and do not provide visibility over or accommodate externally available information.

The core focus of existing platforms which overlap with regulatory assessment are internal legal knowledge management services. Therefore, these platforms only enable a legally-trained user to locate specific regulatory information via typical search criteria.

There is a desire for technology which can determine which regulatory information is relevant to an organisation and to obtain the regulatory information.

It is an object of the present invention to provide a method and system for locating regulatory information which overcomes the disadvantages of the prior art, or at least provides a useful alternative.

### SUMMARY OF INVENTION

According to a first aspect of the invention there is provided a computer-implemented method for locating regulatory information, including:

constructing a corporate profile;

identifying regulatory information from a plurality of sources; and

mapping the corporate profile to the identified regulatory information to locate relevant regulatory information.

The corporate profile may be constructed, at least in part, automatically.

The corporate profile may be validated by a user.

Each regulatory information may be associated with metadata including its status.

A monitoring module may be constructed for each identified regulatory information. The monitoring module may regularly monitor the regulatory information at the source and updates the status of the regulatory information.

The located relevant regulatory information may be is categorised into a plurality of categories. The categories may include directly relevant and indirectly relevant. The located relevant regulatory information may be categorised based upon a plurality of rules. The rules may utilise information within the corporate profile and/or within the profile of the corporate entity's customers and/or suppliers.

The identified regulatory information may be processed to identify topics within the regulatory information. An ontological methodology may be used to process the identified regulatory information. The identified regulatory information may be processed to identify the relevance of topics within the regulatory information. The identified topics may be displayed to a user.

The located relevant regulatory information may be displayed to a user.

The method may further include:

Generating an alert in respect of regulatory information based upon input from a user;

Monitoring regulatory information in accordance with the alert; and

Transmitting a message to the user when the alert is triggered.

According to a further aspect of the invention there is provided system for locating regulatory information, including:

At least one processor configured to construct a corporate profile, to receive identification of regulatory information from a plurality of sources, and to map a corporate profile to identified regulatory information to locate relevant regulatory information;

A communication module configured to communicate within each of the plurality of sources to retrieve regulatory information via the identification; and

A user device configured to display data related to the relevant regulatory information to a user.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a block diagram illustrating a regulatory monitoring system in accordance with an embodiment of the invention;

FIG. 4: shows a table illustrating a portion of an exemplary ontology for use with an embodiment of the invention;

FIG. 5: shows a flow diagram illustrating an ontological method in accordance with an embodiment of the invention;

FIG. 6: shows a screenshot illustrating a user interface to facilitate construction of a corporate profile in accordance with an embodiment of the invention;

FIGS. 7a and 7b:
show screenshots illustrating the display of relevant regulatory information and associated information located in accordance with an embodiment of the invention;

FIGS. 8a and 8b:
show screenshots illustrating the display of a regulatory initiative selected from a list of relevant regulatory information located in accordance with an embodiment of the invention;

FIG. 9: shows a screenshot illustrating the display of relevant regulatory information to which a selected topic has been assigned in accordance with an embodiment of the invention; and

FIG. 10: shows a screenshot illustrating a user interface to enable a user to search for regulatory initiatives in accordance with an embodiment of the invention.

### DETAILED DESCRIPTION OF PREFERRED EMBODIMENTS

The present invention provides a method and system for locating regulatory information.

The inventors have constructed a system which provides for the creation of a corporate profile for an organisation. This profile is used to map to relevant regulatory information extracted from a plurality of sources. In this way, relevant regulatory information from multiple sources can be obtained easily by a user.

Furthermore in some embodiment, automated alerts can provide to the user visibility of changes and updates related to topic trends in regulatory initiatives as well as to follow the life cycle of a regulation from draft to implementation.

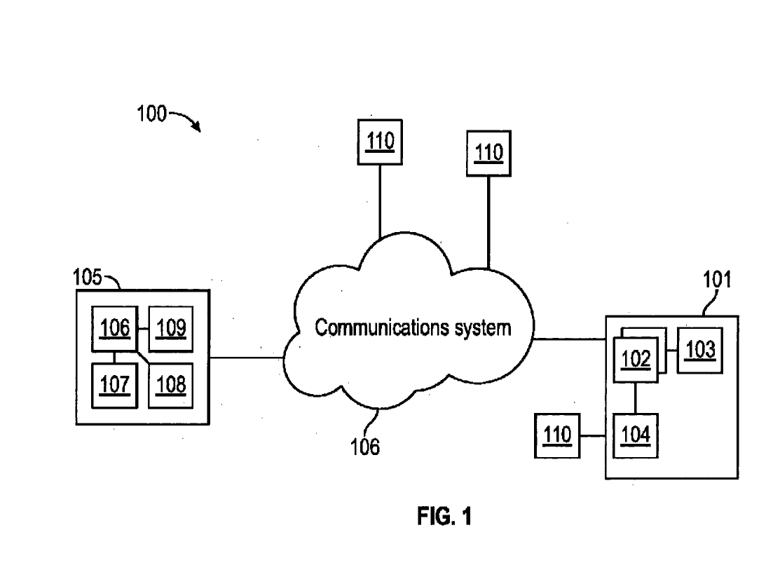

In FIG. 1, a system 100 in accordance with an embodiment of the invention is shown.

A server 101 is shown. The server 101 includes at least one processor 102, a memory 103, and a communications module 104.

It will be appreciated that the server 101 may exist distributed across a plurality of apparatus linked by a communications network or system.

A user device 105 including a processor 106, a memory 107, an input 108 and a display 109 is also shown. The user device 105 may be a computing apparatus such as a desktop, laptop, tablet, or similar. The input 108 may be touch-screen, pointer device, touch-pad, keyboard, or similar, and the display 109 may be a touch-screen, LED/LCD screen, projector, or any other electronic display.

One of the processors 102 may be configured to construct a corporate profile for an organisation. The processor 102 may construct the profile with the assistance of input provided from the user via the user device 105.

The processor 102 may be further configured to identify regulatory information at a plurality of different sources 110.

The information may be identified using links or URIs (Universal Resource Identifiers) to the information. The links may be stored within the memory 103. The links may be defined manually, automatically or a combination of the two.

The communications module 104 may be configured for communicating with one or more of the plurality of sources 105, for example, via a communications system 106 to retrieve the data.

In one embodiment, data from the plurality of sources 106 is collated by the server 101 and stored in the memory 103 for later retrieval.

The processor 102 may be further configured to map a constructed corporate profile to the regulatory information to determine relevant regulatory information for the organisation.

The processor 102 may be further configured to transmit the relevant regulatory information to the user device 105 via the communications module 104.

One of the at least one processors 102 may be further configured to generate analysis using the organisation profiles.

The memory 103 may be configured to store the data, the formed profile, and/or the analysis.

The communications module 104 may also be configured to transmit relevant regulatory information to the user device 105 via, for example, the communications system.

The user device 105 may be further configured to receive and display the relevant regulatory information within a user interface to the user via the display 109 and input 108.

The communications system 106 may be a communications network, or combination of networks comprised of wireless (such as wifi or cellular) or wired networks (such as Ethernet).

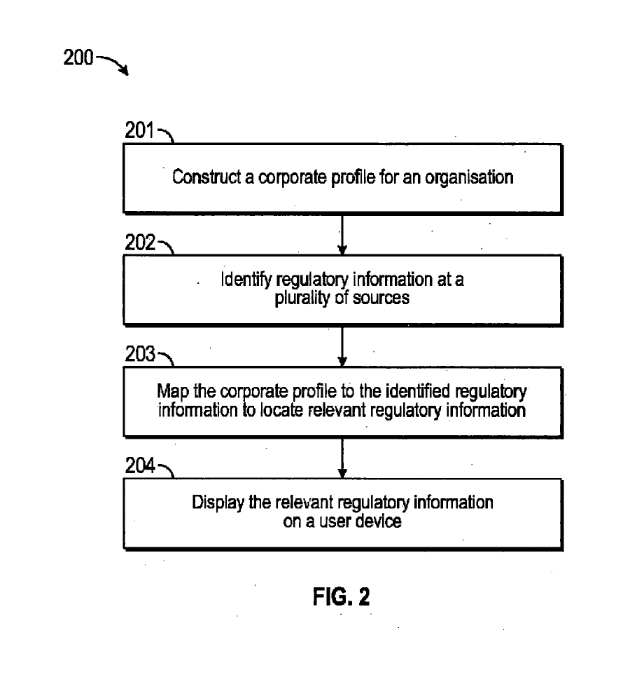

Referring to FIG. 2, a method 200 in accordance with an embodiment of the invention will be described.

In step 201, a corporate profile is constructed for an organisation. The corporate profile may include any of the following information:
a) Sectors of interest (such as markets and suppliers);
b) Geographies of interest (such as locations of headquarters, markets and suppliers); and
c) Topics of interest.

The corporate profile may be completed, at least in part, automatically by analysing information available about the organisation. Automatically generated elements of the corporate profile may be validated by a user at a user device.

The corporate profile may represent the organisation directly or a hypothetical variation of the organisation. For example, for the latter, the corporate profile may act as a scenario for the organisation.

In step 202, regulatory information from a plurality of sources is identified. The sources and regulatory information may include initiatives undertaken by governmental actors, initiatives undertaken by market-regulators, initiatives by market associations or non-profit organisations and initiatives issued by industry associations.

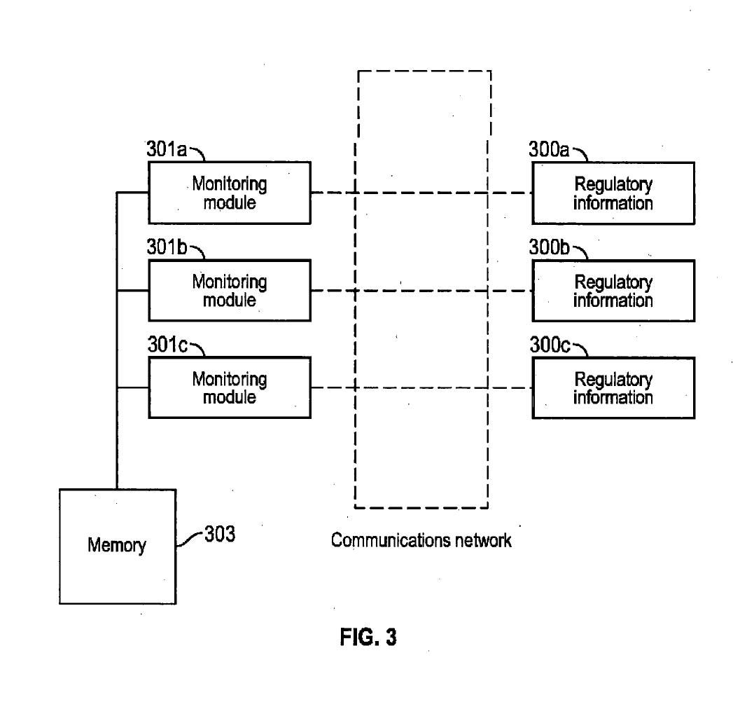

A monitoring module may be created for each source to monitor and update the status of the regulatory information. A monitoring module system will be described in relation to FIG. 3.

Each regulatory information may be associated with metadata or classification information. The association or classification may be manual, automatic, or a combination of both.

The metadata/classification may include the origin of the regulatory information (i.e. governmental, market associations, etc.), date of coming into force, binding force and other status information, sector restriction, name of issuer, etc.

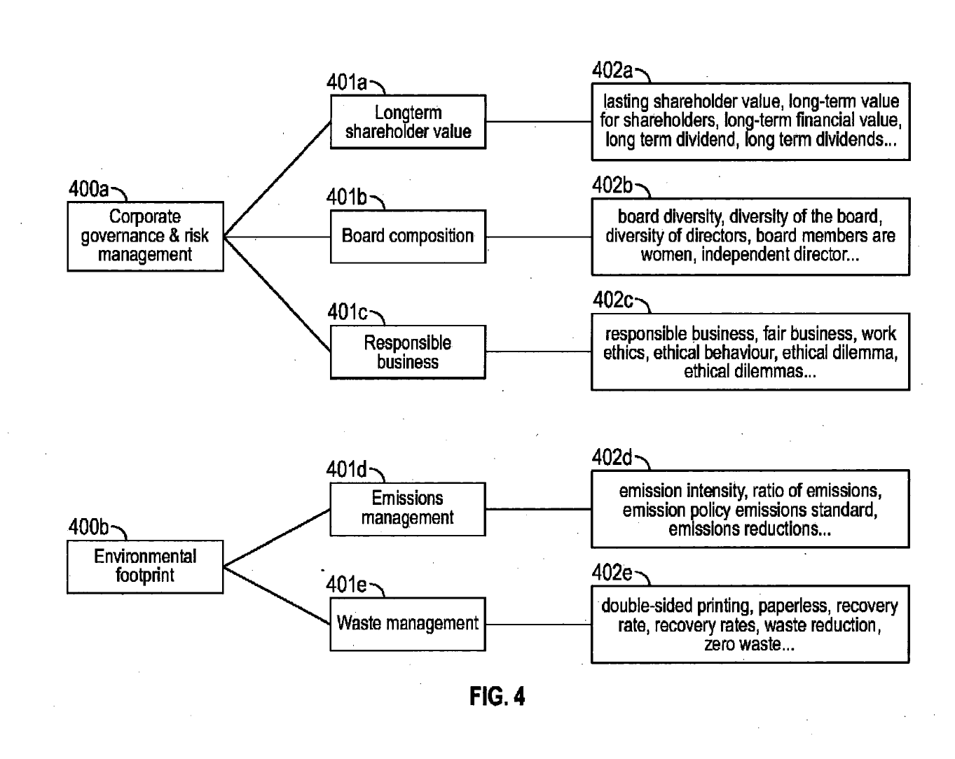

The classification may also include the assignment of relevant topics to each regulatory information. The relevant topics may be selected from an ontological framework such as described in relation to FIG. 4. The relevant topics may be further classified based upon their location within the regulatory information. For example, if the relevant topics appear within a disclosure requirement within the regulatory information, these topics may be classified as “topic within disclosure”, and topics appearing outside the disclosure requirement may be classified as “topics outside disclosure”.

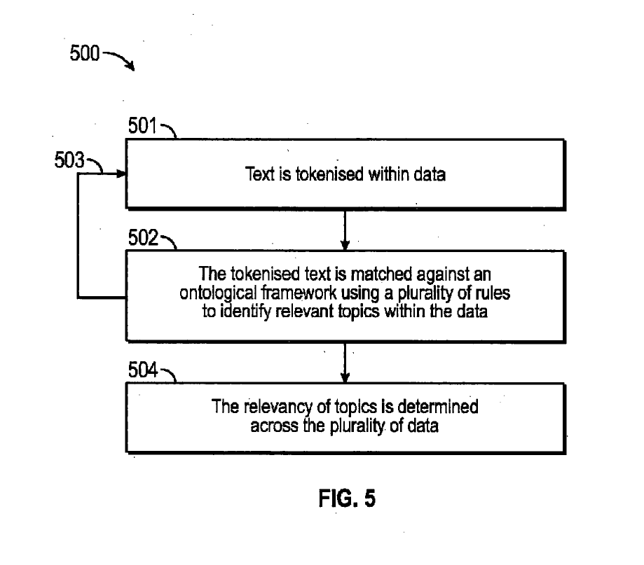

In one embodiment, each regulatory information is classified using an ontological method, such as that described in relation to FIG. 5.

In step 203, the corporate profile is mapped to the identified regulatory information to locate relevant regulatory information.

The relevant regulatory information may be displayed to a user on a user device in step 204.

Where the relevant regulatory information is classified in relation to topics, a summary of topics across the relevant regulatory information may also be displayed to the user.

The method may also include a step of categorising the located regulatory information into categories (for example, directly relevant to the organisation, indirectly relevant, or globally/regionally relevant). The categorising may occur via the use of a plurality of rules. At least some of the rules may utilise data within the corporate profile and/or the organisation's customers/suppliers. The data may include sector, and/or geography.

Examples of rules are shown below:
a) Regulatory information is categorised into directly relevant where the regulatory information is relevant to a country which is also the organisation's headquarters;
b) Regulatory information is categorised into indirectly relevant where the regulatory information is relevant to a country which is also a market served by the organisation or a supplier's location; and
c) Regulatory information is categorised into globally relevant where the regulatory information is not restricted to a specific country.

The relevant regulatory information may include a plurality of regulatory initiatives and the following may be displayed to a user:

a) a title name;

b) a description;

c) the degree of binding force;

d) relevant topics (e.g. assigned during classification) and their classification (e.g. inside or outside disclosure);

e) date of entry into force;

f) date of latest update on the initiative;

g) text on the evolution of the initiative (past and future);

h) issuer's name and type;

i) language of the original text; and

j) sector of application of the given legal instrument and sources

In some embodiments, the user may also search for specific regulatory initiatives.

In some embodiments, an asynchronous alert system may monitor existing regulatory information for a user. The system may be configured by the user to construct one or more alerts to monitor specific regulatory information, to monitor regulatory information identified as relevant in step 203, or to monitor regulatory information which is classified by reference to an ontology (such as shown in FIG. 4) such that one or more topics are deemed relevant to the regulatory information. In the latter case, the user may specify monitoring of specific topics. The monitored regulatory information may be existing regulatory information such that monitoring includes identification of changes, or possible regulatory information such that monitoring includes identification of the creation of regulatory information meeting the configuration specified by the user.

The alert system may in real-time or periodically monitor the regulatory information in accordance with configuration by the user and transmit to the user regulatory information and/or meta-data about the regulatory information that triggers the alerts. The meta-data may be, for example, status information about the regulatory information (e.g. in force, expired, etc.).

The alert system may utilise the monitoring module system described below to monitor existing regulatory information.

With reference to FIG. 3, a monitoring module system will be described.

For each regulatory information 300a, 300b, and 300c, a corresponding monitoring module 301a, 301b, and 301c may be constructed.

Periodically the monitoring module 301 may use a link 302 to the regulatory information 300 to determine the status of the regulatory information 300. For example, if the regulatory information 300 is in draft, in force, or expired.

The status of the regulatory information 300 may be stored in a memory 303 for access during mapping of a corporate profile to relevant regulatory information.

For illustrative purposes only, FIG. 4 shows a portion of an exemplary ontological framework for use with an embodiment of the invention.

The ontological framework may include a plurality of categories (400a and 400b), each category (400a and 400b) associated with a plurality of topics (401a to 401e), and each topic (401a to 401e) may be associated with a plurality of terms (402a to 402e). The terms (402a to 402e) may be words, phrases or other units of information which can be tokenised within text.

In the example shown in FIG. 4, category 400a is “Corporate governance & Risk management”. This is associated with three topics (401a, 401b, and 401c). Topic 401a is “Longterm shareholder value” and is associated with a plurality of terms 402a (lasting shareholder value, long-term value for shareholders, long-term financial value, long term dividend, long term dividends and others not shown).

Referring to FIG. 5, an ontological method will be described in accordance with an embodiment of the invention.

In step 501, a processor (e.g. processor 102) tokenises text within data. Tokenisation involves splitting up a text using a vocabulary and rules into terms and punctuation.

In step 502, a processor (e.g. processor 102) matches the tokenised text against an ontological framework using a plurality of rules to identify relevant topics within the data.

At least part of the tokenised text may be matched against the terms within the ontological framework. Each matching term is associated with a topic such that occurrences of a matching term within the document are associated with a topic.

The plurality of rules may include any of the following rules:
a) identifying locations within the data to use tokenised text;
b) identifying locations within the data to define weights for the tokenised text; and
c) classifying the located topics on degree of importance.

The plurality of rules may be selected from a larger set of rules. The plurality of rules may be selected based upon a category for the data. For example, when the method is applied in relation to Corporate Social Responsibility and Sustainability, the data may be categorised into one of sustainability report, SEC filing, financial annual report, integrated report and Web sites, and each of the categories may be associated with a specific selection of rules.

The number of associations within the document for each topic is used to generate a ranking for the topics from the ontology. One or more of the plurality of rules may identify whether the associations are used to contribute to the ranking based upon the location of the matched terms (e.g. only terms within specific sections of the document contribute).

One or more of the plurality of rules may increase the weight given to certain associations (for example, based upon the location of the matched terms such as terms within a key section of the document).

In one embodiment, multiple matching terms associated with one topic within a single sentence are weighted the same as a single matching term associated with the topic in a sentence.

One or more of the plurality of rules may be used to classify the topics on degree of importance (e.g. high, medium, low importance). For example, if the document has 40 topics, then the top 30% may be classified as high; out of the remaining topics, if the topic has over 4 associations then it is classified as medium; and the remaining topics may be classified as low.

In one embodiment, the above method is applied to a plurality of data as shown at step 503. Each data may represent a document. In this embodiment, a further step 504 may be included to determine the relevancy of topics across the plurality of data. At some of the data may fall within different categories. For example, one document may be a sustainability report, and another document may be a financial report. The further step 504 may utilise rules based upon the category of the data to determine the weight or relevance of the classification of topics for that document. The further step may, for each topic, classify the topic across the plurality of data based upon any one or combination of the following:
a) where multiple data exist within a category, the highest classification given to that topic across that category;
b) if a predefined category specifies a higher classification for the topic than other categories, the classification of that predefined category (for example, if a financial report classifies a topic as high and a sustainability report classifies a topic as medium than the topic across the reports is classified as high); and/or
c) an average for the classification of the topic across the data.

In one embodiment, the method may include a yet further step of generating a proportional importance for a topic within a data or across a plurality of data may be generated for an entity (for example, a company). This proportional importance may be measured against other entities or against earlier or later generated data to provide a comparison within a cluster of entities or across time respectively.

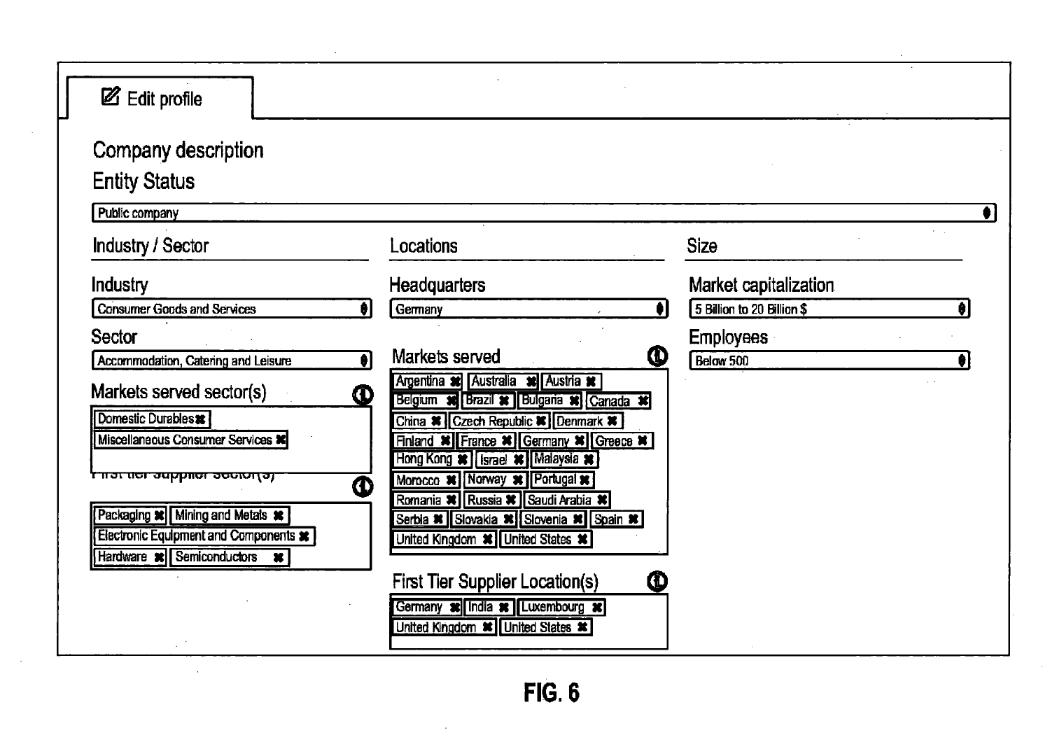

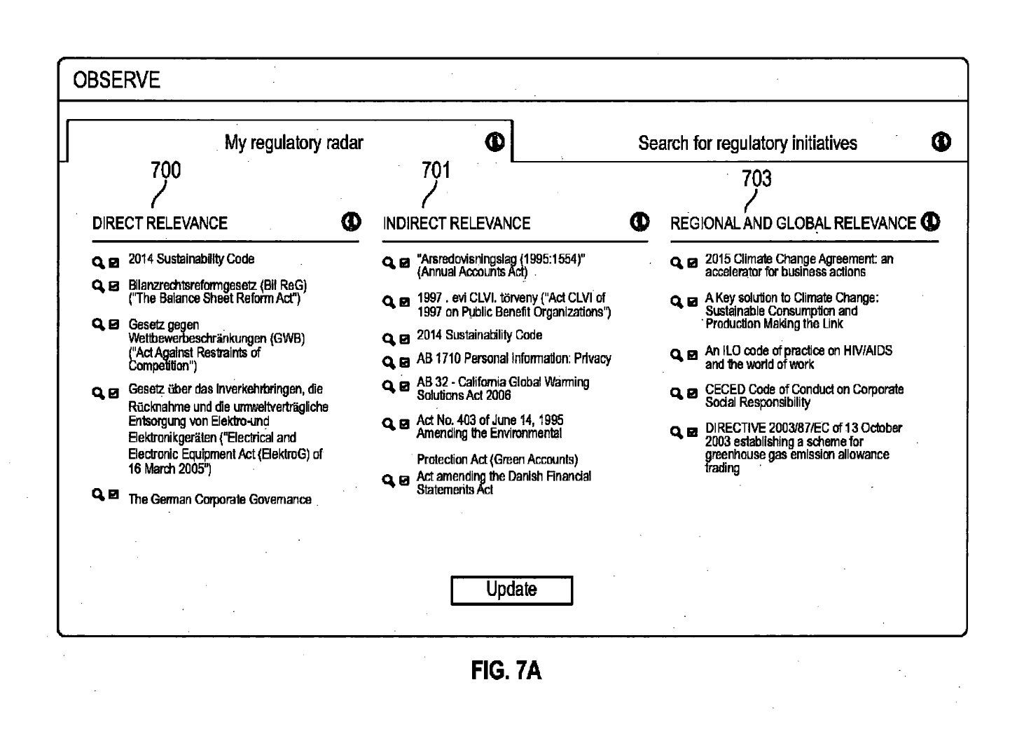

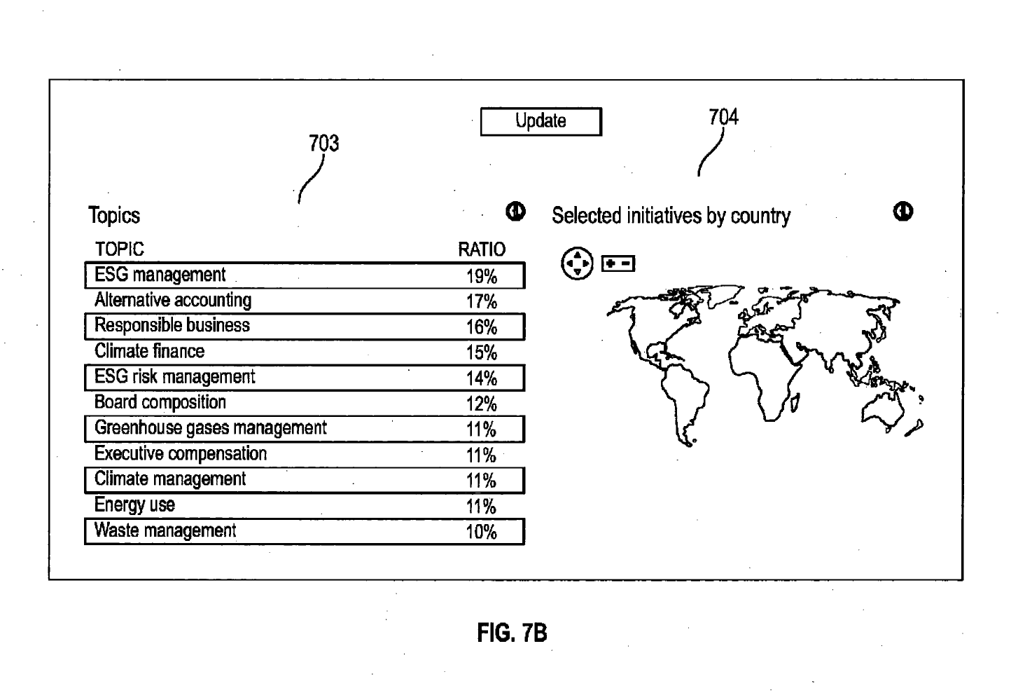

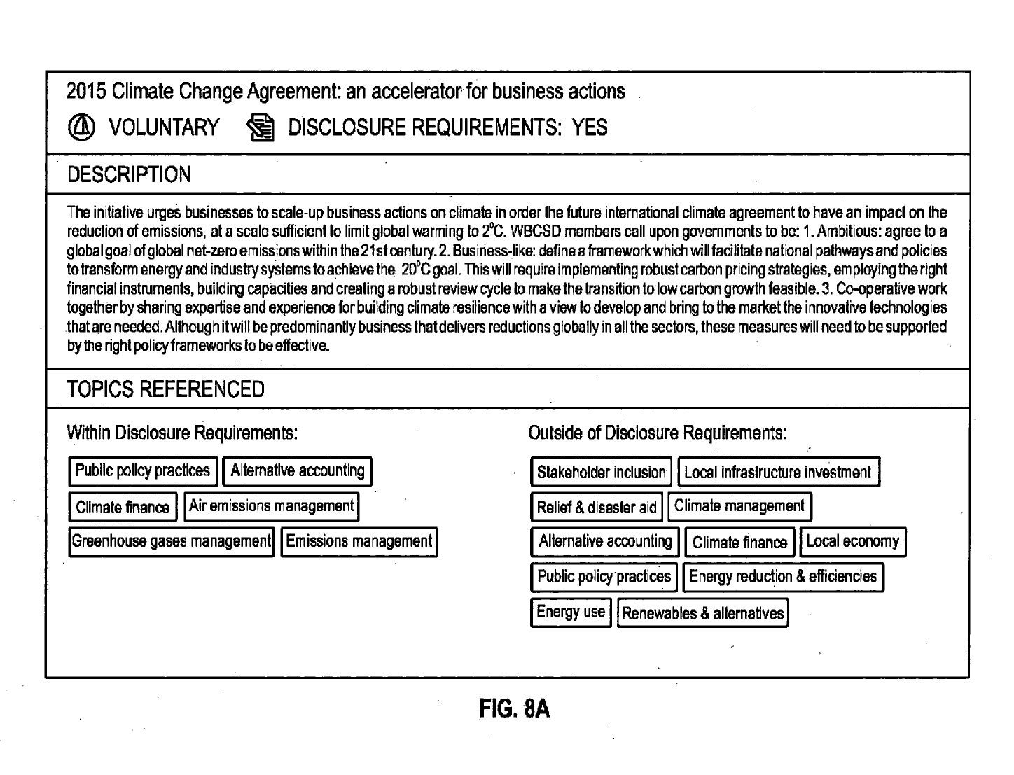

An exemplary user interface for facilitating the definition of information by a user to construct a corporate profile in accordance with an embodiment of the invention is shown in FIG. 6.

An exemplary display of relevant regulatory information located by a method accordance with an embodiment of the invention is shown in FIGS. 7a and 7b.

Directly relevant regulatory initiatives are shown at 700. Indirectly relevant regulatory initiatives are shown at 701. Regional and globally relevant regulatory initiatives are shown at 702.

The proportion of topics assigned to all the regulatory initiatives is displayed in table 703.

A map showing geographic applicability of the regulatory initiatives is shown at 704.

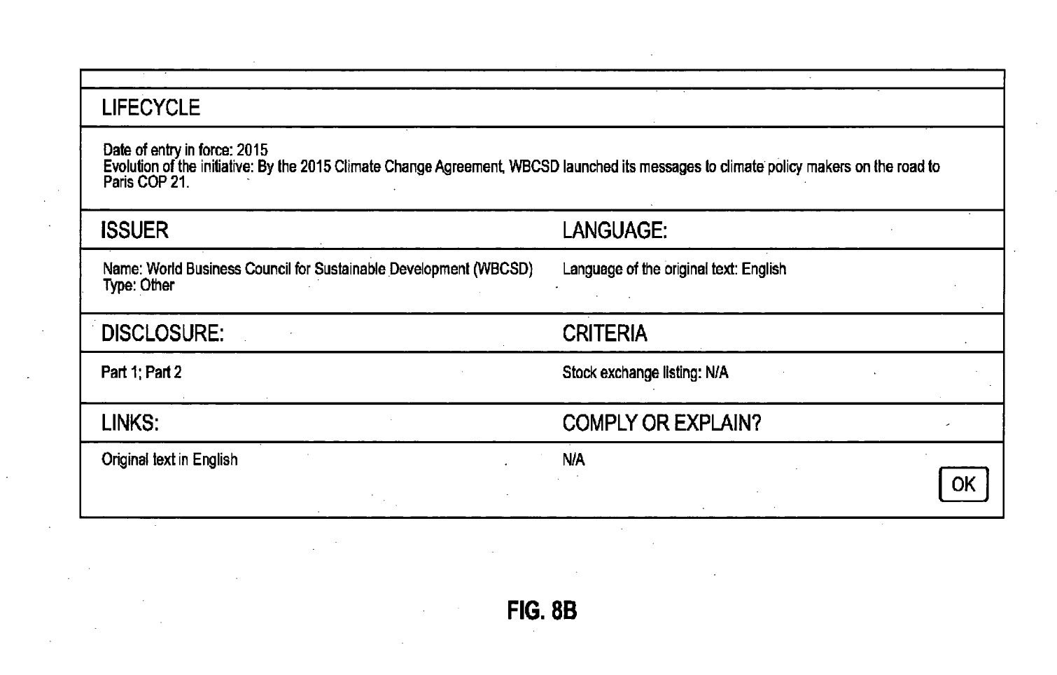

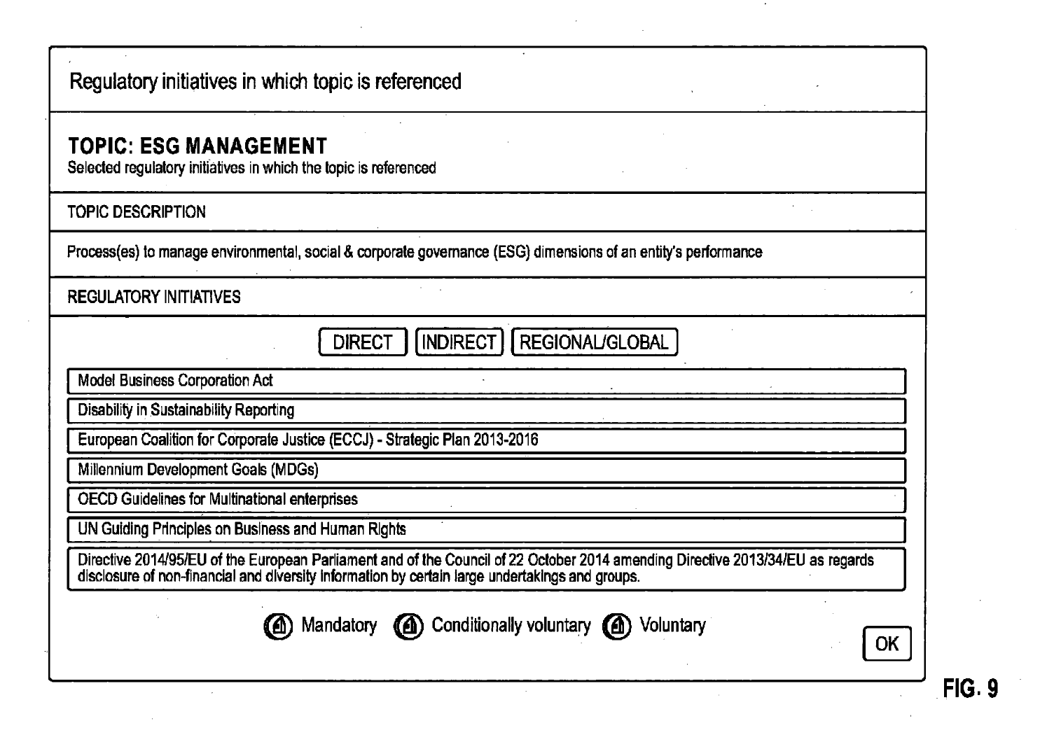

The display is receptive at 700, 701, and 702 to user interaction to select specific regulatory initiatives and then to display the selected initiative as shown in FIGS. 8a and 8b, at 703 to user interaction to select a specific topic and then to display the relevant regulatory initiatives to which topics are assigned as shown in FIG. 9 and at 704 to user interaction to select specific geographies of interest and then to display regulatory initiatives relevant to the select geography/ies.

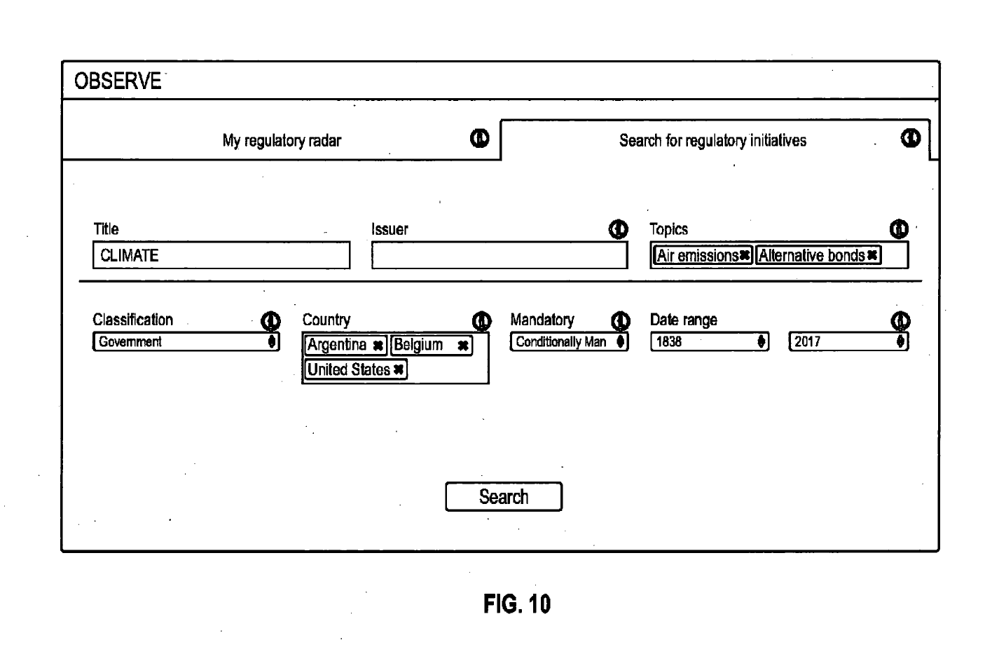

An exemplary user interface to enable a user to search across the regulatory initiatives in accordance with an embodiment of the invention is shown in FIG. 10.

A potential advantage of some embodiments of the present invention is that a user does not need to understand the nuances of local, national, or international law to locate regulatory information which is relevant to their organisation.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method for locating regulatory information, including:
constructing a corporate profile;
identifying regulatory information from a plurality of sources; and
mapping the corporate profile to the identified regulatory information to locate relevant regulatory information.

2. A method as claimed in claim 1, wherein the corporate profile is constructed, at least in part, automatically.

3. A method as claimed in claim 2, wherein the corporate profile is validated by a user.

4. A method as claimed in claim 1, wherein each regulatory information is associated with metadata including its status.

5. A method as claimed in claim 1, wherein a monitoring module is constructed for each identified regulatory information.

6. A method as claimed in claim 5, wherein the monitoring module regularly monitors the regulatory information at the source and updates the status of the regulatory information.

7. A method as claimed in claim 1, wherein the located relevant regulatory information is categorised into a plurality of categories.

8. A method as claimed in claim 7, wherein the categories include directly relevant and indirectly relevant.

9. A method as claimed in claim 8, wherein the located relevant regulatory information is categorised based upon a plurality of rules.

10. A method as claimed in claim 9, wherein the rules utilise information within the corporate profile and/or within the profile of the corporate entity's customers and/or suppliers.

11. A method as claimed in claim 1, wherein the identified regulatory information is processed to identify topics within the regulatory information.

12. A method as claimed in claim 11, wherein an ontological methodology is used to process the identified regulatory information.

13. A method as claimed in claim 11, wherein the identified regulatory information is processed to identify the relevance of topics within the regulatory information.

14. A method as claimed in claim 11, wherein the identified topics are displayed to a user.

15. A method as claimed in claim 1, wherein the located relevant regulatory information is displayed to a user.

16. A method as claimed in claim 1, further including:
Generating an alert in respect of regulatory information based upon input from a user;
Monitoring regulatory information in accordance with the alert; and
Transmitting a message to the user when the alert is triggered.

17. A system for locating regulatory information, including:
At least one processor configured to construct a corporate profile, to receive identification of regulatory information from a plurality of sources, and to map a corporate profile to identified regulatory information to locate relevant regulatory information;
A communication module configured to communicate within each of the plurality of sources to retrieve regulatory information via the identification; and
A user device configured to display data related to the relevant regulatory information to a user.

18. (canceled)
